(19) United States
(12) Patent Application Publication
(10) Pub. No.: US 2026/0287377 A1
(43) Pub. Date: Sep. 24, 2026

(54) INFORMATION PROCESSING DEVICE, VEHICLE, ROUTE DETERMINATION METHOD, AND STORAGE MEDIUM

(71) Applicant: MITSUBISHI ELECTRIC CORPORATION, Tokyo (JP)

(72) Inventors: Miki ARAI, Tokyo (JP); Dongsuk PARK, Tokyo (JP); Takayasu HASHIMOTO, Tokyo (JP); Yuri KUBOTA, Tokyo (JP); Misato WATANABE, Tokyo (JP)

(73) Assignee: MITSUBISHI ELECTRIC CORPORATION, Tokyo (JP)

(21) Appl. No.: 19/466,561

(22) Filed: Feb. 2, 2026

Related U.S. Application Data
(63) Continuation of application No. PCT/JP2023/029143, filed on Aug. 9, 2023.

(51) Int. Cl. G01C 21/34

(52) U.S. Cl. CPC G01C 21/3492

(57) ABSTRACT

An information processing unit according to the present disclosure includes a route finding unit that performs a judgement process of judging whether at least one of a first stop or a second stop will occur on each of route candidates on the basis of signal information representing a light color switching timing of a traffic light and traffic congestion information representing a situation of occurrence of traffic congestion, and determines a route to be traveled by a vehicle from among the route candidates using a judgment result obtained by the judgment process, where the first stop is a stop of the vehicle due to a light color of the traffic light, the second stop is a stop of the vehicle due to traffic congestion, and the route candidates are candidates for a route from a boarding point to a destination of a user-passenger of the vehicle.

### CROSS-REFERENCE TO RELATED APPLICATION

This application is a continuation application of International Application PCT/JP2023/029143, filed on Aug. 9, 2023, and designating the U.S., the entire contents of which are incorporated herein by reference.

### BACKGROUND OF THE INVENTION

### 1. Field of the Invention

The present disclosure relates to an information processing device, a vehicle, a route determination method, and a storage medium for finding a route to be traveled by a vehicle.

### 2. Description of the Related Art

A technique for finding a route of a vehicle to a destination is known. Japanese Patent No. 5872229 discloses a technique of calculating an estimated value of fuel consumption on the basis of a traveling time and an idling stop time of a vehicle, and finding a route that minimizes the estimated value of fuel consumption.

The technique described in Japanese Patent No. 5872229 enables finding of a route that reduces fuel consumption. However, the technique described in Japanese Patent No. 5872229 does not take into consideration a viewpoint of preventing a user-passenger of a vehicle from being involved in a crime.

The present disclosure has been made in view of the above, and an object thereof is to obtain an information processing device capable of reducing the possibility of involvement of a user-passenger of a vehicle in a crime.

### SUMMARY OF THE INVENTION

In order to solve the above problems and achieve an object, an information processing device according to the present disclosure includes: a route finding unit to perform a judgement process of judging whether at least one of a first stop or a second stop will occur on each of route candidates on a basis of signal information and traffic congestion information, and to determine a route to be traveled by a vehicle from among the route candidates using a judgement result obtained by the judgement process, the signal information representing a light color switching timing of a traffic light, the traffic congestion information representing a situation of occurrence of traffic congestion, the first stop being a stop of the vehicle due to a light color of the traffic light, the second stop being a stop of the vehicle due to traffic congestion, the route candidates being candidates for a route from a boarding point to a destination of a user-passenger of the vehicle.

### BRIEF DESCRIPTION OF THE DRAWINGS

FIG. 1 is a diagram illustrating an exemplary configuration of a vehicle according to a first embodiment;

FIG. 2 is a flowchart illustrating an example of route determination process in the information processing unit of the first embodiment;

FIG. 3 is a diagram illustrating an example of a route determined by a route determination method of the first embodiment;

FIG. 4 is a diagram illustrating an example of a route determination system of the first embodiment;

FIG. 5 is a diagram illustrating an exemplary configuration of a manually driven vehicle of the first embodiment;

FIG. 6 is a diagram illustrating an exemplary configuration of a computer system that implements an information processing unit and an information processing device of the first embodiment;

FIG. 7 is a flowchart illustrating an example of route determination process in the information processing unit of a second embodiment; and

FIG. 8 is a flowchart illustrating an example of route determination process in the information processing unit of a third embodiment.

### DETAILED DESCRIPTION OF THE PREFERRED EMBODIMENTS

An information processing device, a vehicle, a route determination method, and a storage medium having a program stored therein according to embodiments will hereinafter be described in detail with reference to the drawings.

### First Embodiment

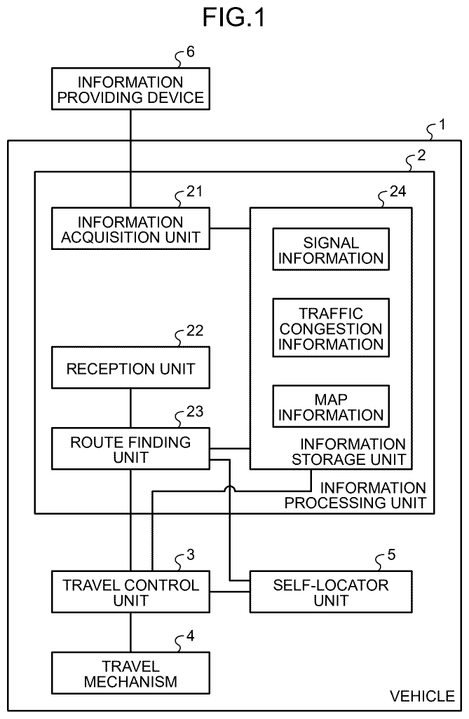

FIG. 1 is a diagram illustrating an exemplary configuration of a vehicle according to a first embodiment. A vehicle 1 of the present embodiment includes an information processing unit 2, a travel control unit 3, a travel mechanism 4, and a self-locator unit 5. The vehicle 1 can carry a user who is a user of the vehicle 1 and can transport the user to a destination. Although FIG. 1 illustrates an example in which the vehicle 1 is a self-driving vehicle capable of automatic driving, the application of the present embodiment is not limited to a self-driving vehicle, but can also be a manually driven vehicle driven by a driver as described later. The present embodiment can be applied also to a vehicle capable of switching between automatic driving and manual driving.

The information processing unit 2 is an information processing device that finds a route of the vehicle 1 (i.e., a route to be traveled by the vehicle 1). The information processing unit 2 includes an information acquisition unit 21, a reception unit 22, a route finding unit 23, and an information storage unit 24.

The information acquisition unit 21 acquires information by receiving information from an information providing device 6. For example, the information acquisition unit 21 acquires, from the information providing device 6, signal information representing a light color switching timing of a traffic light (traffic light machine), that is, a timing of switching of a lighting color of a traffic light, and traffic congestion information representing a situation of occurrence of congestion, and stores the signal information and the traffic congestion information acquired, in the information storage unit 24.

The signal information may be, for example, information representing a signal period representing a length of one cycle in which the signal is lit in order of blue, yellow (or blinking of blue), and red, a lighting time period of each lighting color, and a reference time, or may be information directly representing scheduled times at which the lighting color changes from blue to yellow, yellow to red, and red to blue, respectively. The reference time is, for example, a reference time for directly obtaining the time at which lighting of each color of the traffic light starts, and is, for example, a start time of one cycle of one of the lighting colors. In a case where the start of one cycle is the start of lighting of blue, the reference time can be the time of the start of lighting of blue in a certain cycle. In this case, the start time of lighting of blue of the signal can be obtained by adding an integral multiple of the signal period to the reference time. The reference time is not limited thereto, and may be set to enable the time at which lighting of each color of the traffic light starts to be directly obtained. The reference time may be a past time or a future time. Note that the signal information may be determined by a system that manages signal lighting, or may be information estimated from a result acquired by a sensor such as a camera that detects a flow of traffic. In addition, the information processing unit 2 may include an estimation unit (not illustrated) that estimates signal information and may operate in such a manner that the information acquisition unit 21 acquires a detection result of a sensor such as a camera that detects a flow of traffic, from the sensor; the estimation unit estimates the signal information using the detection result; and the signal information estimated is stored in the information storage unit 24.

The information providing device 6 may be a roadside device, a management device that manages information on traffic, or a distribution device that acquires signal information and congestion information from the management device, and distributes the signal information and the congestion information. In addition, the information processing unit 2 may acquire information transmitted from the information providing device 6 via a network of one of various types such as the Internet or a mobile phone network, or may receive the information via another device (not illustrated). For example, the information processing unit 2 may receive information transmitted from the information providing device 6 by inter-vehicle communication via another vehicle 1. Although FIG. 1 illustrates a single device as the information providing device 6, a plurality of information providing devices 6 may be present. For example, an information providing device 6 that transmits congestion information and an information providing device 6 that transmits signal information may be different devices. Furthermore, an information providing device 6 that provides signal information and congestion information of an applicable area may be provided in each area, and the information acquisition unit 21 may acquire the signal information and the congestion information from a plurality of information providing devices 6 associated with a plurality of respective areas.

The reception unit 22 receives an input of a destination and notifies the route finding unit 23 of the destination received. For example, the reception unit 22 may receive an input of a destination from a user-passenger of the vehicle 1 or from a user other than the user-passenger of the vehicle 1. For example, in a case where the user-passenger of the vehicle 1 is a minor child, the destination may be input by a person such as a parent or an instructor of the user. In addition, the reception unit 22 may directly receive an input through a user's operation, or may receive information representing a destination from a terminal device such as a user-operable mobile terminal.

The information storage unit 24 stores the congestion information, the signal information, and map information. The map information is information representing a map including information on roads, and includes the location of each road, the number of lanes of each road, the traveling direction of each lane, the locations of traffic lights, regulation information representing regulations such as one-way streets and stops, and the like. The map information may also include information representing a curvature of a road curve, a road gradient, the degree of road surface irregularities, and the like. The map information may further include information illustrating, in each block on the map, a situation of occurrence of crimes (types and frequency of crimes that occurred) occurred in the past, such as a security map. Furthermore, the map information may include information representing brightness in each block. In addition, the map information may be information representing a static map, among high-precision three-dimensional map data including dynamic and quasi-dynamic information, such as a dynamic map. Furthermore, in a case where a dynamic map includes at least one of the signal information and the congestion information, that information may be acquired as the dynamic map.

The route finding unit 23 determines a route to be traveled by the vehicle 1, i.e., a route of the vehicle 1, to cause the vehicle 1 to travel from a departure point (boarding point) to a destination with a minimum number of stops, on the basis of the signal information and the congestion information stored in the information storage unit 24. The route finding unit 23 notifies the travel control unit 3 of the route determined. For example, the route finding unit 23 performs a judgement process of judging whether at least one of a first stop or a second stop will occur on each of route candidates on the basis of the signal information and the congestion information, where the first stop is a stop of the vehicle 1 due to the light color of a traffic light, the second stop is a stop of the vehicle 1 due to congestion, and the route candidates are candidates for a route from the boarding point to the destination of the user. The route finding unit 23 then determines a route to be traveled by the vehicle 1, from among the route candidates using the judgement result obtained by the judgement process. In addition, for example, the route finding unit 23 may determine the route of the vehicle 1 on the basis of at least one of the stop time period and the number of stops of the vehicle 1 on the route of the vehicle 1 from among the route candidates on which it has been judged in the judgement process that at least one of the first stop and the second stop will occur. Specifically, for example, the route finding unit 23 may determine a route candidate having the smallest number of stops as the route of the vehicle 1 or a route candidate having the smallest maximum value of the stop time period on the route candidate as the route of the vehicle 1. The route determination method used in the route finding unit 23 is not limited thereto.

Note that the departure point is set to, for example, a current location of the vehicle 1 indicated by location information (described later) received by the route finding unit 23 from the self-locator unit 5. However, the departure point is not limited thereto, and the reception unit 22 may also receive an input for the departure point, and the reception unit 22 may notify the route finding unit 23 of the departure point. A route determination method used in the route finding unit 23 will be described later in detail.

The self-locator unit 5 identifies the self-location of the vehicle 1, and outputs location information representing the self-location identified, to the travel control unit 3 and to the route finding unit 23. The self-locator unit 5 identifies the self-location by, for example, performing positioning using a satellite positioning system such as a global positioning system (GPS) or a global navigation satellite system (GNSS), but the method of identifying the self-location in the self-locator unit 5 is not limited thereto. Note that when the location information is not used in the route finding unit 23, the location information does not need to be output from the self-locator unit 5 to the route finding unit 23.

The travel control unit 3 controls the travel mechanism 4 on the basis of the route received from the route finding unit 23 to perform travel control through automatic driving of the vehicle 1. For example, the travel control unit 3 controls the travel mechanism 4 on the basis of information acquired by a sensor (not illustrated) such as a camera for detecting an obstacle, a light detection and ranging (LiDAR), or a millimeter wave sensor, on the basis of the location information received from the self-locator unit 5, and on the basis of the map information stored in the information storage unit 24. Note that the travel control of the automatic driving of the vehicle 1 is not limited to this as long as the vehicle 1 is controlled to travel on the route received from the route finding unit 23, and may be performed in any manner. A general method can be used, and thus a detailed description thereof will be omitted.

In addition, map information for automatic driving, which is map information used by the travel control unit 3, may be map information different from the map information stored in the information storage unit 24. In this case, the travel control unit 3 performs travel control on the basis of map information for automatic driving stored in a map information storage unit (not illustrated) in the vehicle 1. For example, the map information stored in the information storage unit 24 may be two-dimensional map information, and the map information for automatic driving may be a dynamic map. In a case where a dynamic map is used as the map information for automatic driving, information to be updated may be acquired by the information acquisition unit 21 or by a transmission-reception unit (not illustrated).

The travel mechanism 4 is a mechanism for causing the vehicle 1 to travel, and includes, for example, a plurality of mechanisms for causing the vehicle 1 to travel, such as a device for accelerator operation such as an accelerator pedal, a steering device, and a brake.

In the present embodiment, the route finding unit 23 determines the route of the vehicle 1 to cause the vehicle 1 to arrive at the destination with a minimum number of stops. This can reduce the possibility of involvement of the user-passenger of the vehicle 1 in a crime when the vehicle 1 stops. In particular, in a case where the vehicle 1 is a self-driving vehicle and the user-passenger of the vehicle 1 is a child, taking measures for preventing the child from being involved in a crime is essential. In the present embodiment, the vehicle 1 can travel to the destination with a minimum number of stops of the vehicle 1, thereby enabling a reduction in the possibility of involvement of the child in the vehicle 1 in a crime. Note that the user-passenger of the vehicle 1 is not limited to a child.

Note that, in the above example, the route finding unit 23 notifies the travel control unit 3 of the determined route, but the operation is not limited thereto. The route finding unit 23 may store route information representing the determined route in the information storage unit 24 or in a route information storage unit (not illustrated) in the vehicle 1. In this case, the travel control unit 3 performs travel control of the vehicle 1 with reference to the route information stored in the information storage unit 24 or in the route information storage unit.

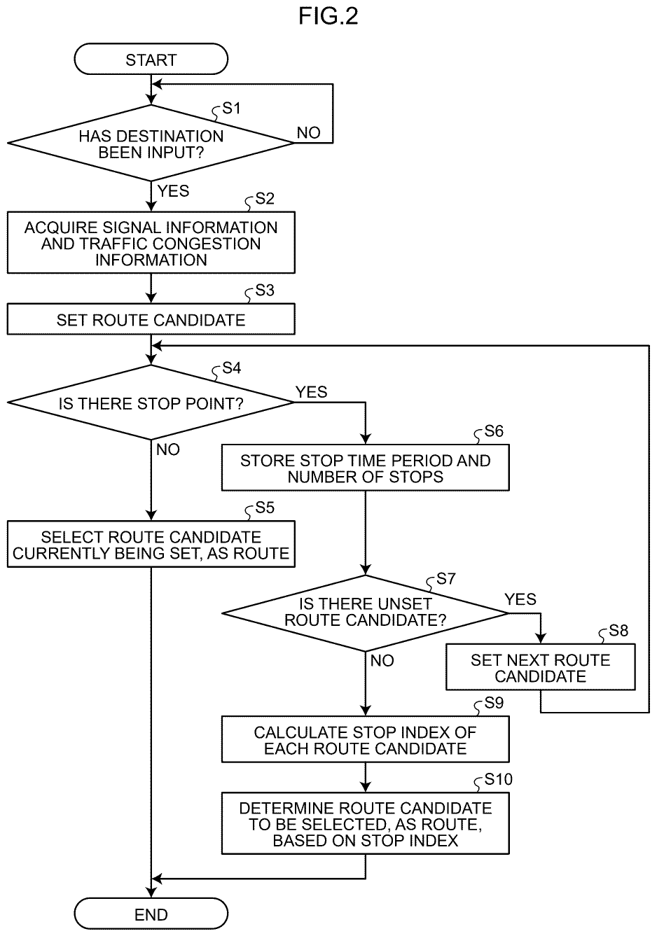

A route determination method in the information processing unit 2 of the present embodiment will next be described. FIG. 2 is a flowchart illustrating an example of route determination process 2 in the information processing unit of the present embodiment. As illustrated in FIG. 2, the information processing unit 2 determines whether a destination has been input (step S1). Specifically, the route finding unit 23 determines whether a destination has been received from the reception unit 22. Note that, as described above, the reception unit 22 may receive an input of not only the destination but also the departure point. In this case, the route finding unit 23 is notified of also the departure point from the reception unit 22.

When there is no input of destination (No in step S1), the information processing unit 2 repeats step S1. If a destination has been input (Yes in step S1), the information processing unit 2 acquires signal information and congestion information (step S2). Specifically, the information acquisition unit 21 acquires, for example, signal information and congestion information for a range where the vehicle 1 can travel, from the information providing device 6, and stores the signal information and the congestion information acquired, in the information storage unit 24. Note that FIG. 2 illustrates step S2 as being performed after step S1, but the timing of performing step S2 is not limited thereto. For example, step S2 may be performed periodically.

The information processing unit 2 sets a route candidate (step S3). Specifically, the route finding unit 23 searches for routes from the departure point to the destination using the map information stored in the information storage unit 24, and sets one of the routes obtained by the search as the route candidate. In step S3, for example, the route finding unit 23 may find a route using a Dijkstra's algorithm, a Bellman-Ford algorithm, or the like, in which intersections are regarded as nodes, and a cost is assigned to an edge connecting nodes to find a route that minimizes the cost, may search for route candidates using a brute-force search, may find a route by a metaheuristic method, or may perform route finding using a method other than these methods. For example, the cost in a Dijkstra's algorithm can be a distance or a required time, but is not limited thereto.

Next, the information processing unit 2 judges whether there is a stop point on the route candidate that has been set (step S4). Specifically, the route finding unit 23 sets a departure time at which the vehicle departs from the departure point, and performs a judgement process of judging whether at least one of stop of the vehicle 1 due to the light color of a traffic light (i.e., stop of the vehicle 1 due to a red light or a yellow light of a traffic light) or stop of the vehicle 1 due to congestion will occur on the route candidate that has been set, by using the congestion information and the signal information stored in the information storage unit 24. The departure time may be a time after a certain time from the current time, or may be specified by the user. Note that the route finding unit 23 may also regard, as a stop, a temporary stop at a point where there is no signal but a stop regulation is imposed, in addition to a stop of the vehicle 1 due to the light color of a traffic light (hereinafter also referred to as stop of the vehicle 1 due to a signal) and a stop of the vehicle 1 due to congestion, or may exclude a point where a stop regulation is imposed, from stop points. Note that when the congestion information is represented in a format such as congestion of Y km at point X, the stop of the vehicle 1 due to congestion may be set to the end of the congestion as the stop point by foreseeing that a stop will occur at the end of the congestion. In addition, when the congestion information includes a stop point and a stop time period caused by congestion, whether there is a stop point is judged on the basis of this information.

When a stop of the vehicle 1 due to a signal will occur, and occurrence of the stop of the vehicle 1 is avoidable by changing at least one of the departure time and the traveling speed, the route finding unit 23 may change at least one of the departure time and the traveling speed. For example, the route finding unit 23 may set a standard traveling speed for each section of a road as an initial value, and when there is a traffic light that will be red in color in a case of traveling at the standard traveling speed, but will be blue in color (lit in blue) in a case of a slight reduction of the traveling speed within the range provided by the regulation, the route finding unit 23 may change the traveling speed to a traveling speed that will cause the traffic light to be passed while the traffic light is lit in blue.

When there is no stop point (No in step S4), the information processing unit 2 selects the route candidate currently being set, as the route (step S5), and terminates the process. Specifically, in step S5, the route finding unit 23 selects the route candidate currently being set, as the route to thus determine the route of the vehicle 1, and notifies the travel control unit 3 of the route determined. Note that when at least one of the departure time and the traveling speed is changed in step S4, the route finding unit 23 notifies the travel control unit 3 of the at least one of the departure time and the traveling speed obtained by changing.

When there is a stop point (Yes in step S4), the information processing unit 2 stores the stop time period and the number of stops (step S6). Specifically, the route finding unit 23 calculates the stop time period at each stop point and the number of stops of the vehicle 1 on the route candidate currently being set, and internally stores the stop time period and the number of stops calculated. Alternatively, the route finding unit 23 may store the stop time period and the number of stops calculated, in the information storage unit 24 or in a temporary storage unit (not illustrated). In a case where the congestion information is represented in a format such as congestion of Y km at point X, the stop time period of the vehicle 1 due to congestion may be obtained by determining a time required for passing through the congestion according to the length of the congestion using a table or the like, and converting the value of Y km into the stop time period using the table. Alternatively, when the congestion information includes a time required for passing through the congestion, such time may be used as the stop time period of the vehicle 1 due to congestion. An example is described here in which the route finding unit 23 calculates the stop time period and the number of stops of the vehicle 1. However, when the stop time period is not used in calculation of a stop index in step S9 described later, calculation of the stop time period may be skipped in step S6, and when the number of stops is not used in calculation of the stop index in step S9 described later, calculation of the number of stops in step S6 may be skipped.

The information processing unit 2 judges whether there is a route candidate that has not yet been set (step S7). Specifically, the route finding unit 23 judges whether there is a route from the departure point to the destination other than the route candidate or route candidates that has or have already been set. Note that even if a route is found that allows the vehicle to depart from the departure point and arrive at the destination through a long circuitous road by making a very long detour, the processing time required for the route finding process and the actual travel time of the vehicle 1 could be excessively long. A limit may therefore be imposed on at least one of the processing time and the travel distance (i.e., travel distance from the departure point to the destination). For example, when the processing time exceeds a threshold in finding a route other than the already-set route candidates, the route finding unit 23 may judge, in step S7, that there is no route candidate that has not yet been set. In addition, for example, when the information processing unit 2 tries to find a route other than the already-set route candidates, and this results in only finding a solution equal to or more than a travel distance threshold, the information processing unit 2 may judge, in step S7, that there is no route candidate that has not yet been set.

When there is a route candidate that has not yet been set (Yes in step S7), the information processing unit 2 sets a next route candidate (step S8) and repeats the process from step S4. In step S8, specifically, the route finding unit 23 searches for routes from the departure point to the destination other than the already-set route candidates, and sets one of the routes obtained by the search as the route candidate.

When there is no route candidate that has not yet been set (No in step S7), the information processing unit 2 calculates a stop index of each route candidate (step S9). Specifically, the route finding unit 23 calculates a stop index, which is an index related to the stop of the vehicle 1 on the route candidate, using at least one of the stop time period and the number of stops of the vehicle 1 for each route candidate stored. The stop index is an index indicating the degree of stoppage of the vehicle 1 on each route candidate. The number of stops is, but not limited to, a sum of a first number of times and a second number of times, where the first number of times is the number of stops of the vehicle 1 due to the light color of a traffic light (first stops) and the second number of times is the number of stops of the vehicle 1 due to congestion (second stops). The route finding unit 23 may count the first number of times and the second number of times separately.

The stop index may be, for example, the number of stops (i.e., the number of stop points) of the vehicle 1 on that route candidate, a maximum value of the stop time periods at respective stop points on that route candidate, the sum of the stop time periods on that route candidate, or a weighted sum of the first number of times and the second number of times. In addition, the stop index may be an index calculated for a combination of the stop time period and the number of stops, or may be an index other than these. For example, the stop index may be the number of stop points at which the stop time period is equal to or longer than a certain value, that is, the number of stops in which the stop time period is equal to or longer than a certain value, among the stop points on that route candidate. In addition, for example, the value of C, where C is the stop index, may be calculated by the following Formula (1), where A₁ is the number of stops in which the stop time period is equal to or longer than a first time period, A₂ is the number of stops in which the stop time period is equal to or longer than a second time period longer than the first time period, A₃ is the number of stops in which the stop time period is equal to or longer than a third time period longer than the second time period, and w₁, w₂, and w₃ are weighting coefficients.

C=w₁·A₁+w₂·A₂+w₃·A₃ (1)

For example, setting the weighting coefficients w₁, w₂, and w₃ to satisfy a relationship of w₁<w₂<w₃ causes the value of C to be greater for a longer stop time period even for a same number of stops. The stop index is not limited to the example described above. Note that the stop index is herein defined such that a lower value thereof provides a higher evaluation score, but is not limited thereto. The stop index may be defined such that a higher value thereof provides a higher evaluation score.

The stop index may further include the number of times of right turn and left turn. Presence of a right turn and/or a left turn is highly likely to result in a stop of the vehicle 1. It is therefore preferable to select a route that allows the vehicle to travel in a straight line as many times as possible. Accordingly, for example, the stop index may be determined on the basis further of the number of times of right turn and left turn in such a manner that a weighted sum of the above-described number of stops and the number of times of right turn and left turn is used as the stop index, or a term of multiplication of the number of times of right turn and left turn by a weighting coefficient is further added to the above Formula (1).

In addition, an operation may be performed in such a manner that the number of stops of the vehicle 1 is counted separately for stops in sections supposed to be unsafe and for other stops, and a larger weighting coefficient is used for the stops in the sections supposed to be unsafe than that for the other sections to calculate the stop index on the basis of the number of stops and the stop time period. Note that, in this case, the map information includes information such as, for example, the number of past occurrences of crimes as information for identifying a section supposed to be unsafe. For example, the stop index may be a weighted sum of the number of stops in sections supposed to be unsafe and the number of stops in other sections, or the stop index may be a weighted sum of a maximum value of the stop time periods in the sections supposed to be unsafe and a maximum value of the stop time periods in the other sections. Furthermore, the stop index may be a weighted sum of the number of stops in sections supposed to be unsafe, the number of stops in other sections, a maximum value of the stop time periods in the sections supposed to be unsafe, and a maximum value of the stop time periods in other sections.

In addition, the vehicle 1 may stop due to a traffic light at an intersection having a traffic light, and accordingly, the number of intersections each having a traffic light may also be taken into consideration in the stop index. That is, the stop index may be determined on the basis further of the number of intersections each having a traffic light.

Next, the information processing unit 2 determines a route candidate to be selected as the route on the basis of the stop index (step S10), and terminates the process. In step S10, specifically, the route finding unit 23 determines a route candidate to be selected as the route, using the stop index of each route candidate calculated in step S9. For example, the route finding unit 23 determines the route candidate having the minimum stop index as the route to be selected. Alternatively, the route finding unit 23 may determine the route candidate to be selected, from among route candidates whose stop indices are equal to or less than a threshold value, according to a selection criterion different from the stop index. The selection criterion different from the stop index may be a travel distance, a required time, or another criterion. Note that when the stop index has been defined such that a larger value thereof provides a higher evaluation score, the route finding unit 23 determines, for example, a route candidate having the maximum stop index as the route to be selected.

As described above, for example, the route finding unit 23 may calculate a first number of stops, which is the number of first stops, and a second number of stops, which is the number of second stops, on the route candidates, on the basis of the congestion information and the signal information, and determine the route to be traveled by the vehicle 1 from among the route candidates using the first number of stops and the second number of stops. For example, the route finding unit 23 may determine a route candidate having a smallest sum of the first number of stops and the second number of stops, as the route to be traveled by the vehicle 1. In addition, the route finding unit 23 may calculate a stop time period at each point where either the first stop or the second stop will occur, on the route candidates, on the basis of the congestion information and the signal information, and determine the route to be traveled by the vehicle 1 from among the route candidates using the stop time periods calculated. For example, the route finding unit 23 may determine a route candidate having a smallest maximum value of the stop time periods, as the route to be traveled by the vehicle 1.

In the example described above, route candidates are set in the route finding process, after which the stop index of each route candidate is calculated, and the route candidate to be selected as the route is then determined using the stop indices calculated. However, the present invention is not limited thereto, and the stop index may be considered in the route finding process. Alternatively, a condition for reducing the stop time period may be considered in the route finding process. For example, in a Dijkstra's algorithm or a Bellman-Ford algorithm, the cost may be set to lead to a higher cost at an edge where a stop occurs, or to lead to a higher cost at an edge that provides a longer stop time period. Furthermore, the cost may be set to lead to a higher cost at an edge including an intersection having a traffic light, or to lead to a higher cost also at an edge where right turn and left turn occur. When a condition for reducing the stop index or the stop time period is considered in the route finding process, this route finding process is performed instead of step S3 illustrated in FIG. 2, and steps S4 to S10 do not need to be performed.

The route determination process described above is an example. It is sufficient that the route finding unit 23 calculates at least one of the number of stops and the stop time period of the vehicle 1 on each of the route candidates on the basis of, for example, the signal information and the congestion information, and determines the route using the calculated value. The specific process of the route determination method is not limited to the example described above.

In addition, in the example described above, the process illustrated in FIG. 2 is performed regardless of the age of the user, but the present invention is not limited thereto. The route finding unit 23 may determine, depending on the age of the user, whether to determine the route using the process illustrated in FIG. 2 or using a usual method. For example, the route finding unit 23 may determine the route using the process illustrated as an example in FIG. 2 when the age of the user is less than a threshold value, and determine the route using a usual method when the age of the user is equal to or higher than the threshold value. Information representing the age of the user may be, for example, input through the reception unit 22 or estimated by the route finding unit 23. The information representing the age of the user may be the age itself or information representing whether the user is a child or an adult. Furthermore, for example, a video of the user may be captured by a camera (not illustrated) provided in the vehicle 1, and the route finding unit 23 may analyze the captured video and estimate the age of the user.

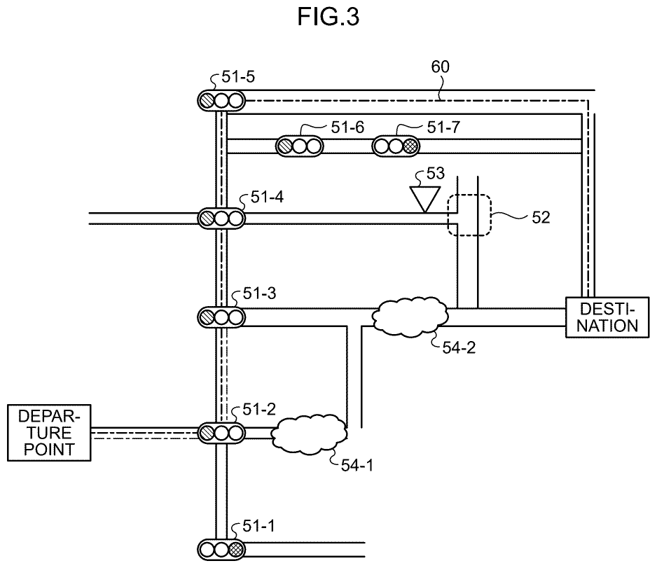

FIG. 3 is a diagram illustrating an example of a route determined by a route determination method of the present embodiment. It is assumed here that the number of stops is used as a stop index as an example. The example illustrated in FIG. 3 assumes that traffic signals 51-1 to 51-7 exist near the departure point and the destination, and there is congestion at two congestion points 54-1 and 54-2. It is assumed that the vehicle departs from the departure point at a departure time T₀, and the estimated arrival time at the traffic light 51-2 is T₁ when the vehicle travels at a standard traveling speed. The traffic light 51-2 is assumed to be blue in color (lit in blue) at T₁. Similarly, it is assumed that due to the blue color on the traffic light 51-2 at T₁, all of the situations are possible in which the vehicle 1 goes straight, turns right, and turns left at the intersection having the traffic light 51-2. In the example illustrated in FIG. 3, after the vehicle goes straight through the traffic light 51-2, congestion is occurring at the congestion point 54-1. If the vehicle 1 turns right at the traffic light 51-2, the traffic light 51-1 will be red at an expected arrival time T₂ of the vehicle 1 at the traffic light 51-1, and if the vehicle 1 turns left at the traffic light 51-2, the traffic light 51-3 will be blue at an expected arrival time T₃ of the vehicle 1 at the traffic light 51-1. In this case, if the vehicle 1 turns right at the traffic light 51-2, the vehicle 1 will stop at the traffic light 51-1.

In contrast, since the traffic light 51-3 will be blue at the expected arrival time T₃, the vehicle 1 does not need to stop. Therefore, the route to go straight through the traffic light 51-2 and a route to turn right at the traffic light 51-2 each have a stop index of larger than that of a route to turn left at the traffic light 51-2. It is also assumed that the traffic lights 51-4, 51-5, and 51-6 will be blue at the expected arrival times of the vehicle 1 at the respective ones of them, and that the traffic light 51-7 will be red at the expected arrival time of the vehicle 1 at the traffic light 51-7. The route to turn right at the traffic light 51-3 has congestion occurring at the congestion point 54-2, and the route to turn right at the intersection between the traffic light 51-4 and the traffic light 51-5 includes the traffic light 51-7 lit in red, thereby causing the vehicle 1 to stop. In addition, the route to turn right at the traffic light 51-4 is provided with a stop sign 53 at an intersection 52 having no traffic light, which will cause a stop due to a temporary stop. Thus, when a temporary stop is also considered as a stop, a stop also occurs on the route to turn right at the traffic light 51-4. In view of the above, in the example illustrated in FIG. 3, a route 60 indicated by the one-dot chain line, for example, is determined as the route of the vehicle 1. Note that when a stop due to a temporary stop is not considered as a stop, the route to turn right at the traffic light 51-4 may be determined as the route of vehicle 1. FIG. 3 illustrates a concept of the route determination method, and the situation of each route and the result of route determination are not limited to the example illustrated in FIG. 3.

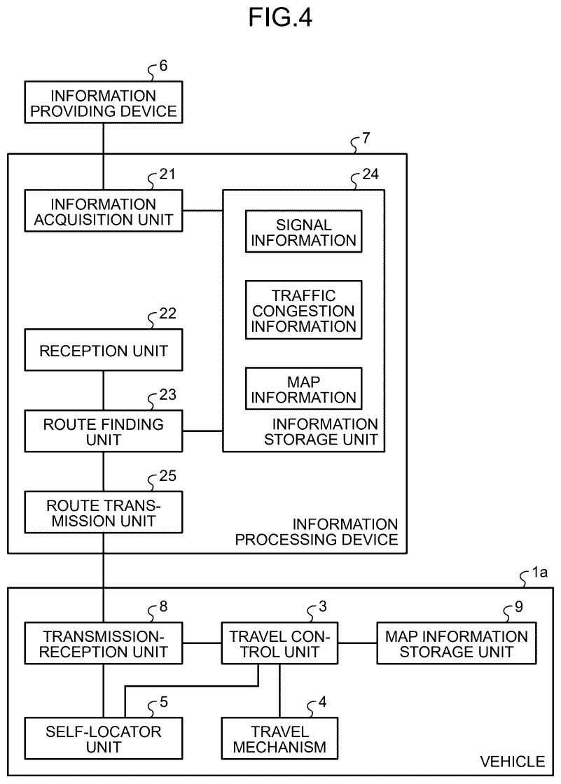

Although FIG. 1 illustrates an example in which the vehicle 1 performs the route determination process of the present embodiment, the route determination process may be performed by a device different from the vehicle. FIG. 4 is a diagram illustrating an example of a route determination system of the present embodiment. The route determination system of the present embodiment includes a vehicle 1a and an information processing device 7, and the route determination process is performed by the information processing device 7. Components having functions similar to those in the example illustrated in FIG. 1 are denoted by the same reference numerals, and duplicate description will be omitted.

The information processing device 7 illustrated in FIG. 4 includes a route transmission unit 25 in addition to the components of the information processing unit 2 illustrated in FIG. 1. The vehicle 1a illustrated in FIG. 4 does not include the information processing unit 2, which has been removed from the vehicle 1 illustrated in FIG. 1, and additionally includes a transmission-reception unit 8 and a map information storage unit 9. In the route determination system illustrated in FIG. 4, the self-locator unit 5 outputs location information representing the self-location of the vehicle 1a to the travel control unit 3 and to the transmission-reception unit 8. The transmission-reception unit 8 transmits the location information to the information processing device 7. Note that when the location information is not used in the route finding unit 23, the location information does not need to be output from the self-locator unit 5 to the transmission-reception unit 8.

The route finding unit 23 in the information processing device 7 illustrated in FIG. 4 performs a route determination process similarly to the route finding unit 23 of the information processing unit 2 illustrated in FIG. 1, and outputs route information representing the route determined, to the route transmission unit 25. The route transmission unit 25 transmits the route information to the vehicle 1a.

The transmission-reception unit 8 of the vehicle 1a receives the route information from the information processing device 7 and outputs the route information received, to the travel control unit 3. The travel control unit 3 controls the travel mechanism 4 on the basis of the route represented in the route information received from the transmission-reception unit 8 to perform travel control of the vehicle 1a. For example, similarly to the travel control unit 3 illustrated in FIG. 1, the travel control unit 3 controls the travel mechanism 4 on the basis of information acquired by a sensor (not illustrated), location information, and map information stored in the map information storage unit 9. The map information stored in the information storage unit 24 of the information processing device 7 may be map information the same as or different from the map information stored in the map information storage unit 9.

Note that the functional division between the vehicle and the information processing device is not limited to the example illustrated in FIG. 4. For example, the example illustrated in FIG. 4 illustrates the reception unit 22 as being provided in the information processing device 7, but the reception unit 22 may be provided in the vehicle 1a. In this case, the destination received by the reception unit 22 is transmitted to the information processing device 7 by the transmission-reception unit 8. The destination is received by a reception unit (not illustrated) in the information processing device 7 and output to the route finding unit 23 by the reception unit. Similarly, when the reception unit 22 receives an input of the departure point, the departure point is transmitted to the information processing device 7.

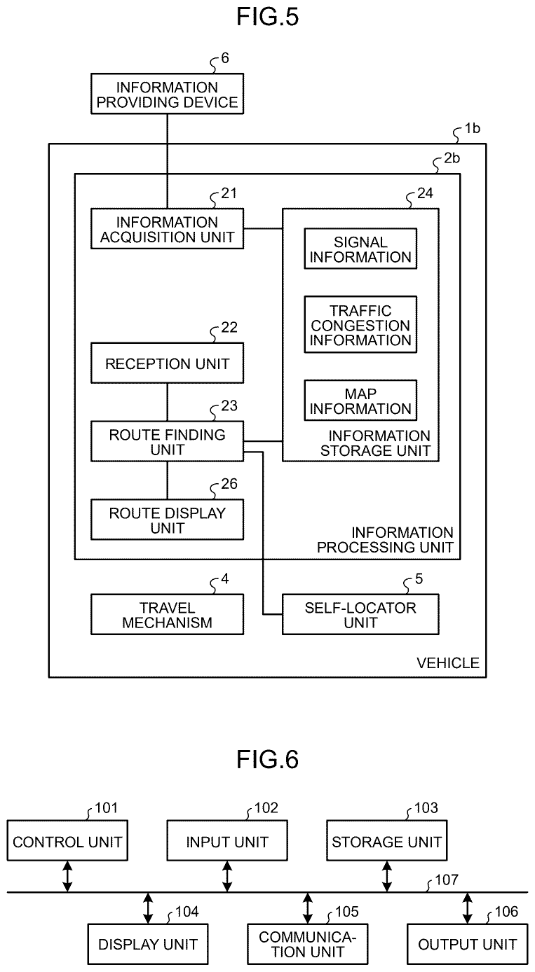

In addition, although the examples illustrated in FIGS. 1 and 4 assume that the vehicles 1 and 1a are self-driving vehicles, the present embodiment can also be applied to a manually driven vehicle. FIG. 5 is a diagram illustrating an exemplary configuration of a manually driven vehicle of the present embodiment. A vehicle 1b illustrated in FIG. 5 is a vehicle driven by a driver. As illustrated in FIG. 5, the vehicle 1b does not include the travel control unit 3, which has been removed from the vehicle 1, and includes an information processing unit 2b instead of the information processing unit 2. Components having functions similar to those in the example illustrated in FIG. 1 are denoted by the same reference numerals, and duplicate description will be omitted.

The information processing unit 2b is similar to the information processing unit 2 illustrated in FIG. 1 except that a route display unit 26 is added to the information processing unit 2 illustrated in FIG. 1. The route finding unit 23 of the information processing unit 2b performs a route determination process similarly to the route finding unit 23 of the information processing unit 2 illustrated in FIG. 1, and outputs route information representing the route determined, to the route display unit 26. The route display unit 26 displays the route represented by the route information. The route display unit 26 may display the route on a map. In this case, this process may be performed in such a manner that the route finding unit 23 reads the map information from the information storage unit 24 and provides the map information to the route display unit 26, or that the route display unit 26 reads the map information from the information storage unit 24 and displays the map information in the form of a map.

Note that, also in a case where a manually driven vehicle is used, the information processing device 7 may perform the route determination process similarly to the case of the example illustrated in FIG. 4. In this case, the vehicle includes the route display unit 26 instead of the travel control unit 3 of the vehicle 1a illustrated in FIG. 4; the route information representing the route determined by the information processing device 7 is received by the transmission-reception unit 8, and the route represented by the route information is displayed by the route display unit 26.

A hardware configuration of the information processing units 2 and 2b and the information processing device 7 of the present embodiment will next be described. Each of the information processing units 2 and 2b and the information processing device 7 of the present embodiment is implemented in such a manner that a program that is a computer program that describes processing to be performed in each of the information processing units 2 and 2b and the information processing device 7 is executed on a computer system, thereby causing the computer system to function as each of the information processing units 2 and 2b and the information processing device 7. FIG. 6 is a diagram illustrating an exemplary configuration of a computer system that implements the information processing units 2 and 2b and the information processing device 7 of the present embodiment. As illustrated in FIG. 6, the computer system includes a control unit 101, an input unit 102, a storage unit 103, a display unit 104, a communication unit 105, and an output unit 106, which are connected to each other via a system bus 107.

In FIG. 6, the control unit 101 is, for example, a processor such as a central processing unit (CPU), and executes a program that describes processing to be performed in each of the information processing units 2 and 2b and the information processing device 7 of the present embodiment. The input unit 102 includes, for example, a keyboard, a button, a mouse, and the like, and is used by a user of the computer system to input a variety of information. The storage unit 103 includes a variety of memories such as a random access memory (RAM) and a read only memory (ROM) and a storage device such as a hard disk, and stores a program to be executed by the control unit 101, necessary data obtained during a process of processing, and the like. The storage unit 103 is also used as a temporary storage area of a program. The control unit 101 and the storage unit 103 together form, for example, processing circuitry. The processing circuit may be formed of one circuit or a plurality of circuits. The display unit 104 includes a display, a liquid crystal display (LCD) panel, or the like, and displays a variety of screens for a user of the computer system. Note that a touch panel that integrates the input unit 102 and the display unit 104 may be used. The communication unit 105 is a receiver and a transmitter that perform communication processing. The output unit 106 is a speaker or the like. Note that FIG. 6 is an example, and the configuration of the computer system is not limited to the example of FIG. 6. For example, the output unit 106 may not be provided.

An operation example of the computer system until the program of the present embodiment becomes executable will now be described. In the computer system having the above-described configuration, a program is installed into the storage unit 103 from, for example, a compact disc (CD)-ROM or a digital versatile disc (DVD)-ROM placed in a CD-ROM drive or in a DVD-ROM drive (not illustrated). The program read from the storage unit 103 is then stored in a main storage area of the storage unit 103 upon execution of the program. In this circumstance, the control unit 101 performs processing to function as each of the information processing units 2 and 2b and the information processing device 7 of the present embodiment according to the program stored in the storage unit 103.

Note that although the above description describes provision of a program that describes processing to be performed in each of the information processing units 2 and 2b and the information processing device 7 using a CD-ROM or a DVD-ROM as a recording medium, the method of providing the program is not limited thereto. For example, a program provided using a transmission medium such as the Internet via the communication unit 105 may be used depending on factors such as the configuration of the computer system and/or the capacity of the program to be provided.

The program of the present embodiment causes, for example, a computer system that determines a route of the vehicle 1 to perform: a step of performing a judgement process of judging whether at least one of a first stop or a second stop will occur on each of route candidates on the basis of signal information and congestion information, where the first stop is a stop of the vehicle 1 due to a light color of a traffic light, the second stop is a stop of the vehicle 1 due to congestion, and the route candidates are candidates for a route from a boarding point to a destination of a user-passenger of the vehicle 1; and a step of determining a route to be traveled by the vehicle 1 from among the route candidates using a judgement result obtained by the judgement process.

The route finding unit 23 illustrated in FIGS. 1, 4, and 5 is implemented by execution of a program stored in the storage unit 103 illustrated in FIG. 6 by the control unit 101 illustrated in FIG. 6. The route finding unit 23 illustrated in FIGS. 1, 4, and 5 is implemented by also using the storage unit 103. The information acquisition unit 21 illustrated in FIG. 1 is implemented in the communication unit 105 illustrated in FIG. 6. The information storage unit 24 is part of the storage unit 103. The reception unit 22 is implemented in at least one of the input unit 102 and the communication unit 105. The route display unit 26 illustrated in FIG. 5 is implemented in the display unit 104 illustrated in FIG. 6. The control unit 101 may be used to control the reception unit 22, the route display unit 26, and the information acquisition unit 21. The information processing units 2 and 2b and the information processing device 7 may be implemented in a plurality of computer systems. In addition, the information processing device 7, for example, may be implemented in a cloud computer system.

The travel control unit 3 illustrated in FIG. 1 and the travel control unit 3 and the map information storage unit 9 illustrated in FIG. 4 are each also implemented in a computer system. The travel control unit 3 illustrated in FIG. 1 and the travel control unit 3 and the map information storage unit 9 illustrated in FIG. 4 are implemented in, for example, processing circuitry including the control unit 101 and the storage unit 103 illustrated in FIG. 6 as an example. In addition, the travel control unit 3 and the information processing unit 2 illustrated in FIG. 1 may be implemented in a single computer system. Moreover, in a case where the self-locator unit 5 illustrated in FIGS. 1, 4, and 5 acquires location information by GNSS positioning, the self-locator unit 5 includes a GNSS antenna, and calculates the location information by the above-described control circuit using a signal received by the GNSS antenna.

As described above, in the present embodiment, the information processing units 2 and 2b and the information processing device 7 determine the route of the vehicle 1 to cause the vehicle 1 to arrive at the destination with a minimum number of stops. This can reduce the possibility of involvement of the user-passenger of the vehicle 1 in a crime when the vehicle 1 stops. In particular, in a case where the vehicle 1 is a self-driving vehicle and the user-passenger of the vehicle 1 is a child, taking crime prevention measures for the child is essential. The route determination method of the present embodiment can reduce the possibility of involvement of the child in a crime.

### Second Embodiment

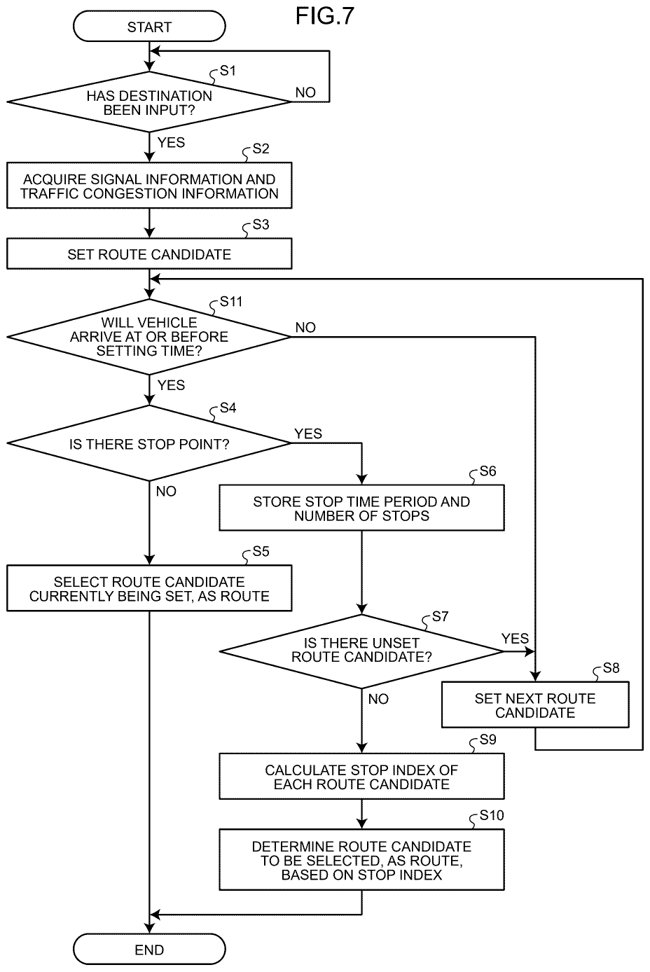

FIG. 7 is a flowchart illustrating an example of route determination process in the information processing unit 2 of a second embodiment. The vehicle 1 of the present embodiment has a configuration similar to that of the first embodiment. Components having functions similar to those in the first embodiment are denoted by the same reference numerals as those of the first embodiment, and duplicate description will be omitted. Although the following description provides an example of operation of the present embodiment in the vehicle 1 having the exemplary configuration illustrated in FIG. 1 of the first embodiment, the operation of the present embodiment can also be similarly applied to the exemplary configurations illustrated in FIGS. 4 and 5 of the first embodiment.

Steps S1 to S3 illustrated in FIG. 7 are similar to those of the example illustrated in FIG. 2 of the first embodiment. After step S3, the information processing unit 2 judges whether the vehicle 1 arrives at or before a setting time (step S11). Specifically, the route finding unit 23 judges whether the vehicle 1 that will travel along a route candidate currently being set will arrive at the destination at or before a setting time. The setting time is a maximum acceptable time as a deviation from the target arrival time, and is, for example, but not limited to, a time (first setting time) when a predetermined time has elapsed since the target arrival time, that is, a time obtained by adding the predetermined time to the target arrival time. At least one of the target arrival time and the setting time may be user-specified. For example, at least one of the target arrival time and the setting time may be set in such a manner that the reception unit 22 receives an input from the user. Alternatively, the target arrival time may be determined according to a linear distance between the departure point and the destination.

When the vehicle 1 will arrive at or before the setting time (Yes in step S11), step S4 and the subsequent steps are performed. When the vehicle 1 will not arrive at or before the setting time (No in step S11), step S8 and the subsequent steps are performed. Steps S4 to S10 are similar to those of the example illustrated in FIG. 2 of the first embodiment.

In the first embodiment, the route of the vehicle 1 is determined to cause the vehicle 1 to arrive at the destination with a minimum number of stops. This however may result in selection of a route requiring more time to reach the destination. In the present embodiment, the information processing unit 2 excludes, from the route candidates to be selected, a route candidate that causes the vehicle 1 to arrive at the destination after the setting time. That is, the information processing unit 2 determines the route to cause the vehicle 1 to arrive at the destination at or before the setting time. This enables the route to be determined to cause the vehicle 1 to arrive at the destination at or before the setting time. In addition, setting the setting time on the basis of the target arrival time specified by the user enables the arrival time of the vehicle 1 at the destination to be close to the target arrival time desired by the user.

Alternatively, a time (second setting time) that is a predetermined time before the target arrival time, that is, a time obtained by subtracting the predetermined time from the target arrival time, may be set as the setting time. In this case, the information processing unit 2 determines, in step S11, whether the vehicle arrives at or after the second setting time. That is, the information processing unit 2 determines the route to be traveled by the vehicle 1 to cause the vehicle 1 to arrive at the destination at or after the second setting time. This can prevent the user-passenger of the vehicle 1 from arriving too early, and reduce a problem that the user is involved in a crime while waiting. In addition, the setting time may be arranged such that a first setting time that is a predetermined time before the target arrival time and a second setting time that is a predetermined time after the target arrival time are set, and that, in step S11, a determination is made whether the vehicle 1 arrives at a time after the first setting time and before the second setting time.

Note that the processing procedure illustrated in FIG. 7 is an example, and the processing procedure is not limited thereto. A condition that the vehicle 1 arrives at or before the setting time may be reflected in the route finding process. For example, a route may be made substantially difficult to be found in the route finding process by setting a cost to a very high value for arrival after the setting time. That is, it is sufficient that the route finding unit 23 determines the route to cause the vehicle 1 to arrive at the destination at or before the setting time with a minimum number of stops of the vehicle 1 until the destination. No limitation is imposed on the specific process. The part of the operation of the present embodiment other than the part described above is similar to that of the first embodiment.

### Third Embodiment

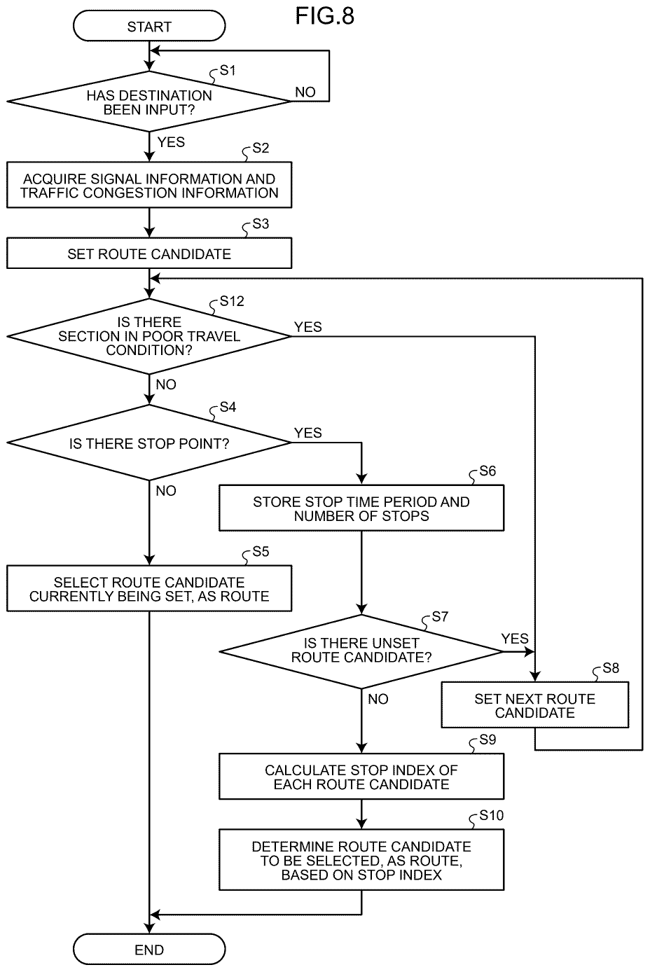

FIG. 8 is a flowchart illustrating an example of route determination process in the information processing unit 2 of a third embodiment. The vehicle 1 of the present embodiment has a configuration similar to that of the first embodiment. Components having functions similar to those in the first embodiment are denoted by the same reference numerals as those of the first embodiment, and duplicate description will be omitted. Although the following description provides an example of operation of the present embodiment in the vehicle 1 having the exemplary configuration illustrated in FIG. 1 of the first embodiment, the operation of the present embodiment can also be similarly applied to the exemplary configurations illustrated in FIGS. 4 and 5 of the first embodiment.

Steps S1 to S3 illustrated in FIG. 8 are similar to those of the example illustrated in FIG. 2 of the first embodiment. After step S3, the information processing unit 2 judges whether there is a section in poor travel condition (step S12). Specifically, the route finding unit 23 judges whether there is a section in poor travel condition on the route candidate currently being set, by using the map information stored in the information storage unit 24. The section in poor travel condition is, for example, but not limited to, at least one of sections including a section supposed to easily cause carsickness, a section supposed to be unsafe, and a dark section.

A section supposed to easily cause carsickness is at least one of sections including a section having many curves, a section having a sharp curve (a curve with a small curvature), a section having a large road gradient, and a section having large road irregularities. In the present embodiment, pieces of information representing these features are included in the map information, and the route finding unit 23 can judge a section having the pieces of information representing these features each exceeding a threshold to be a section supposed to easily cause carsickness. The section supposed to be unsafe is at least one of sections including a section previously having a high crime rate and a section identified as requiring attention in the security map. The present embodiment assumes that the crime occurrence situation, various types of information in the security map, and the like are also included in the map information. The route finding unit 23 judges, on the basis of the map information, whether the route candidate currently being set is a section supposed to be unsafe. Similarly, information representing surrounding brightness is also assumed to be included in the map information, and the route finding unit 23 judges whether the section is a dark section on the basis of the map information.

When there is no section in poor travel condition (No in step S12), step S4 and the subsequent steps are performed. When there is a section in poor travel condition (Yes in step S12), step S8 and the subsequent steps are performed. Steps S4 to S10 are similar to those of the example illustrated in FIG. 2 of the first embodiment. As described in the first embodiment, the route finding unit 23 may determine whether to perform the process illustrated in FIG. 8 or the usual process on the basis of the age of the user.

In the present embodiment, the route is determined to avoid a section in poor travel condition. For example, the route finding unit 23 determines a route to be traveled by the vehicle 1 on the basis of at least one of the curvature of a road curve, the number of curves in a certain range, and the road gradient. This enables a section supposed to easily cause carsickness to be avoided, thereby allowing the user to be less likely to get carsick in the vehicle 1 and to experience more comfortable ride than when the route is set without consideration of a section supposed to easily cause carsickness. In particular, in a case where the user-passenger of the vehicle 1 is a child, the child can easily get carsick. Determination of the route to avoid the section supposed to easily cause carsickness can reduce or prevent carsickness of the child.

In addition, reduction or prevention of carsickness of the child may also be performed in the travel control. For example, the travel control unit 3 may perform travel control such as avoiding abrupt acceleration-deceleration, providing a speed limit, and avoiding abrupt steering. For example, travel control may be performed while imposing a restriction to limit at least one of the absolute value of the acceleration, the speed, and the change amount of the steering wheel operation to a threshold or less. Moreover, whether to impose a restriction on the travel control may be determined according to the age of the user also in the travel control.

Furthermore, the route finding unit 23 may determine the route to be traveled by the vehicle 1 on the basis of the crime occurrence situation. Avoiding a section such as a section supposed to be unsafe can further reduce the possibility of involvement of the user in a crime as compared with the first embodiment.

Note that the processing procedure illustrated in FIG. 8 is an example, and the processing procedure is not limited thereto. A condition of avoiding a section in poor travel condition may be reflected in the route finding process. For example, a route may be made substantially difficult to be found in the route finding process by setting a cost to a very high value for a section in poor travel condition. That is, it is sufficient that the route finding unit 23 determines the route to avoid a section in poor travel condition and to cause the vehicle 1 to arrive at the destination with a minimum number of stops. No limitation is imposed on the specific process. The part of the operation of the present embodiment other than the part described above is similar to that of the first embodiment.

Note that the second embodiment and the present embodiment may be combined. For example, step S12 may be added after step S11 illustrated in FIG. 7.

The information processing device according to the present disclosure has an effect of capability of reducing the possibility of involvement of a user-passenger of a vehicle in a crime.

The configurations described in the above embodiments each illustrate an example of the aspects, can be combined with another known technique, and can be combined with each other. Part of the configurations can be omitted or modified without departing from the gist.

What is claimed is:

1. An information processor comprising:
a route finding circuitry to perform a judgement process of judging whether at least one of a first stop or a second stop will occur on each of route candidates on a basis of signal information and traffic congestion information, and to determine a route to be traveled by a vehicle from among the route candidates using a judgement result obtained by the judgement process, the signal information representing a light color switching timing of a traffic light, the traffic congestion information representing a situation of occurrence of traffic congestion, the first stop being a stop of the vehicle due to a light color of the traffic light, the second stop being a stop of the vehicle due to traffic congestion, the route candidates being candidates for a route from a boarding point to a destination of a user-passenger of the vehicle, wherein
when the first stop will occur on one of the route candidates, and occurrence of the first stop is avoidable by changing at least one of a departure time or a traveling speed of the vehicle, the route finding circuitry changes at least one of the departure time or the traveling speed of the vehicle on the one of the route candidates to avoid the occurrence of the first stop.

2. The information processor according to claim 1, wherein the route finding circuitry calculates a first number of stops and a second number of stops on each of the route candidates on a basis of the traffic congestion information and the signal information, and determines the route to be traveled by the vehicle from among the route candidates using the first number of stops and the second number of stops, the first number of stops being a number of the first stops, the second number of stops being a number of the second stops.

3. The information processor according to claim 2, wherein one of the route candidates having a smallest sum of the first number of stops and the second number of stops is determined as the route to be traveled by the vehicle.

4. The information processor according to claim 1, wherein the route finding circuitry calculates a stop time period at each point where either the first stop or the second stop will occur, on each of the route candidates on a basis of the traffic congestion information and the signal information, and determines the route to be traveled by the vehicle from among the route candidates using the stop time periods calculated.

5. The information processor according to claim 4, wherein one of the route candidates having a smallest maximum value of the stop time periods on the route candidates is determined as the route to be traveled by the vehicle.

6. The information processor according to claim 1, wherein the route to be traveled by the vehicle is determined by using a setting time, the setting time being an earliest acceptable arrival time of the vehicle at the destination or a latest acceptable arrival time of the vehicle at the destination.

7. The information processor according to claim 6, wherein
the setting time is a first setting time that is a predetermined time after a target arrival time specified by the user, and
the route to be traveled by the vehicle is determined to cause the vehicle to arrive at the destination at or before the first setting time.

8. The information processor according to claim 6, wherein
the setting time is a second setting time that is a predetermined time before a target arrival time specified by the user, and
the route to be traveled by the vehicle is determined to cause the vehicle to arrive at the destination at or after the second setting time.

9. The information processor according to claim 1, wherein the route finding circuitry determines the route to be traveled by the vehicle further on a basis of at least one of a curvature of a road curve, a number of curves in a certain range, or a road gradient.

10. The information processor according to claim 1, wherein the route finding circuitry determines the route to be traveled by the vehicle further on a basis of a crime occurrence situation.

11. The information processor according to claim 1, wherein when the traffic congestion information indicates that a traffic congestion has a length equal to or longer than a threshold, the route finding circuitry judges that the second stop due to that traffic congestion will occur.

12. An information processor comprising:
a route finding circuitry to perform a judgement process of judging whether at least one of a first stop or a second stop will occur on each of route candidates on a basis of signal information and traffic congestion information, and to determine a route to be traveled by a vehicle from among the route candidates using a judgement result obtained by the judgement process, the signal information representing a light color switching timing of a traffic light, the traffic congestion information representing a situation of occurrence of traffic congestion, the first stop being a stop of the vehicle due to a light color of the traffic light, the second stop being a stop of the vehicle due to traffic congestion, the route candidates being candidates for a route from a boarding point to a destination of a user-passenger of the vehicle, wherein
in determination of the route of the vehicle, the route finding circuitry performs a route determination process to determine the route to be traveled by the vehicle from among the route candidates using the judgement result obtained by the judgement process when the user-passenger of the vehicle is a child, and determines the route to be traveled by the vehicle using a method different from the route determination process when the user-passenger is an adult.

13. An information processor comprising:
a route finding circuitry to calculate stop information on a basis of signal information and traffic congestion information, and to determine a route to be traveled by a vehicle using the stop information calculated, the stop information being at least one of a stop time period and a number of stops on a route candidate from a boarding point to a destination of a user-passenger of the vehicle, the signal information representing a light color switching timing of a traffic light, the traffic congestion information representing a situation of occurrence of traffic congestion, wherein
when a stop of the vehicle due to a light color of the traffic light will occur on the route candidate, and occurrence of the stop is avoidable by changing at least one of a departure time or a traveling speed of the vehicle, the route finding circuitry changes at least one of the departure time or the traveling speed of the vehicle on the route candidate to avoid the occurrence of the stop.

14. A vehicle capable of carrying a user, the vehicle comprising:
a route finding circuitry to perform a judgement process of judging whether at least one of a first stop or a second stop will occur on each of route candidates on a basis of signal information and traffic congestion information, and to determine a route to be traveled by a vehicle from among the route candidates using a judgement result obtained by the judgement process, the signal information representing a light color switching timing of a traffic light, the traffic congestion information representing a situation of occurrence of traffic congestion, the first stop being a stop of the vehicle due to a light color of the traffic light, the second stop being a stop of the vehicle due to traffic congestion, the route candidates being candidates for a route from a boarding point to a destination of a user-passenger of the vehicle, wherein
when the first stop will occur on one of the route candidates, and occurrence of the first stop is avoidable by changing at least one of a departure time or a traveling speed of the vehicle, the route finding circuitry changes at least one of the departure time or the traveling speed of the vehicle on the one of the route candidates to avoid the occurrence of the first stop.

15. The vehicle according to claim 14, comprising:
a travel control circuitry to perform travel control through automatic driving of the vehicle on a basis of the route determined by the route finding circuitry.

16. A route determination method for use in an information processor that determines a route of a vehicle, the route determination method comprising:
performing a judgement process of judging whether at least one of a first stop or a second stop will occur on each of route candidates on a basis of signal information and traffic congestion information, the signal information representing a light color switching timing of a traffic light, the traffic congestion information representing a situation of occurrence of traffic congestion, the first stop being a stop of the vehicle due to a light color of the traffic light, the second stop being a stop of the vehicle due to traffic congestion, the route candidates being candidates for a route from a boarding point to a destination of a user-passenger of the vehicle; and
determining a route to be traveled by a vehicle from among the route candidates using a judgement result obtained by the judgement process, wherein
in determining the route, when the first stop will occur on one of the route candidates, and occurrence of the first stop is avoidable by changing at least one of a departure time or a traveling speed of the vehicle, at least one of the departure time or the traveling speed of the vehicle on the one of the route candidates is changed to avoid the occurrence of the first stop.

17. A non-transitory computer-readable storage medium having a program stored therein, the program causing a computer system that determines a route of a vehicle to perform:
performing a judgement process of judging whether at least one of a first stop or a second stop will occur on each of route candidates on a basis of signal information and traffic congestion information, the signal information representing a light color switching timing of a traffic light, the traffic congestion information representing a situation of occurrence of traffic congestion, the first stop being a stop of the vehicle due to a light color of the traffic light, the second stop being a stop of the vehicle due to traffic congestion, the route candidates being candidates for a route from a boarding point to a destination of a user-passenger of the vehicle; and
determining a route to be traveled by a vehicle from among the route candidates using a judgement result obtained by the judgement process, wherein
in determining the route, when the first stop will occur on one of the route candidates, and occurrence of the first stop is avoidable by changing at least one of a departure time or a traveling speed of the vehicle, at least one of the departure time or the traveling speed of the vehicle on the one of the route candidates is changed to avoid the occurrence of the first stop.
